(19) United States
(12) Patent Application Publication
(10) Pub. No.: US 2022/0408768 A1
(43) Pub. Date: Dec. 29, 2022

(54) HEART SHAPED FROZEN PUREE BABY FOOD

(71) Applicant: VINEEESHIA YVETTE HAYNES, ARLINGTON, TX (US)

(72) Inventor: VINEEESHIA YVETTE HAYNES, ARLINGTON, TX (US)

(21) Appl. No.: 17/358,078

(22) Filed: Jun. 25, 2021

(51) Int. Cl. A23L 19/00; A23L 3/36; A23L 5/10

(52) U.S. Cl. CPC A23L 19/09; A23L 3/364; A23L 5/15

(57) ABSTRACT

A mixture of baked fruits and vegetables blended with water; homemade puree; organic frozen puree; heart shaped puree baby food. Frozen organic puree baby food in heart molded containers, comprising of part water, baked fruits and vegetables to slow the growth of pathogenic bacteria organically.

### BACKGROUND

It all started in 2012 when my first born was ready to begin eating puréed baby food, with my son being a breastfed child my concern had always been about the ingredients used in traditional store bought baby foods. After doing much research on the benefits of homemade puréed baby food, I decided to prepare the purée baby food on my own by purchasing organic fruits and vegetables and using my oven to bake the fruits and vegetables in order to preserve the taste. I then used blender to mix the baked fruits and vegetables along with distilled water to even out the consistency. Once all steps had been complete, I decided to test the purée out myself. The results were quite amazing, knowing that my child would experience the taste of real puréed baby food, made me a proud mom. My son loved it and so did everyone else. I continued this method up until my son was able to chew tabletop foods. Since then, I have birthed four more children which have experienced the same homemade baby food that my first born was able to experience. The results were wonderful with all of my children.

Throughout the years so many parents asked me to make their children my homemade puréed baby food but I was always hesitant. The parents expressed that they love the concept and would love for their children to experience the taste of real baby food, but they did not have the time to prepare the homemade puréed baby food themselves. Which is why I decided to push forward my idea of manufacturing frozen homemade puréed baby food so that every child gets a chance to experience the taste of homemade puréed baby food.

### Process

### Heart Shaped Frozen Puree Baby Food

### Ingredients

Organic Fruits

Organic Vegetables

Distilled Water
1. Bake fresh organic fruits/vegetables
2. Blend baked organic fruits/vegetables with distilled water
3. Pour puree into molded heart trays
4. Freeze puree
5. Place frozen heart shaped fruits/vegetables inside of a air tight sealed containers

### Method

Bake fresh organic fruits/vegetables.
Blend baked organic fruits/vegetables with distilled water.
Pour puree into heart molded container.
Freeze puree
Allow individual heart molded containers filled with puree to thaw before human consumption.

### Composition

### Ingredients: Organic Fruits, Organic Vegetables and Distilled Water

### Use

A method of providing homemade baby food.

### Design

Frozen puree baby food in heart molded containers.

1. The objective of freezing time/temperature preservative free purébaby food to slow the growth of pathogenic bacteria organically; providing healthy baby food.

2. The objective according to claim 1, to naturally preserve purébaby food; preventing contamination of time/temperature puree baby food preservative free.

3. The objective according to claim 2, a method of freezing baby food as a form of natural preservation; providing organic baby food; thawing out puréfor fresh baby food; providing homemade baby food and making baby food without adding anything any other ingredients besides water, fruits or vegetables.
